(19) United States
(12) Patent Application Publication
(10) Pub. No.: US 2018/0211529 A1
(43) Pub. Date: Jul. 26, 2018

(54) TRAFFIC MANAGEMENT SYSTEM

(71) Applicant: ENT. SERVICES DEVELOPMENT CORPORATION LP, Houston, TX (US)

(72) Inventors: Satwant KAUR, San Jose, CA (US); William J. ALLEN, Corvallis, OR (US); Babak MAKKINEJAD, Troy, MI (US); Corey WICK, Plano, TX (US)

(73) Assignee: ENT. SERVICES DEVELOPMENT CORPORATION LP, Houston, TX (US)

(21) Appl. No.: 15/576,622

(22) PCT Filed: May 22, 2015
(86) PCT No.: PCT/US15/32190

§ 371 Date: Nov. 22, 2017

(51) Int. Cl. G08G 1/0967; G08G 1/01

(52) U.S. Cl. CPC G08G 1/0967; G08G 1/0145; G08G 1/0112; G08G 1/0133

(57) ABSTRACT

Example implementations relate to a traffic management system. For example, the traffic management system may receive data from a plurality of connected vehicles. The traffic management system may determine the relative positions of non-connected vehicles to the connected vehicles and may cluster connected vehicles and non-connected vehicles into a flock. The traffic management system may determine a flock traffic pattern and a nature of the flock traffic pattern, based on data received from the connected vehicles.

### BACKGROUND

Some vehicles may be equipped with features, such as anti-lock brakes, traction control, electronic stability control, obstacle detection sensors, and the like, that may help a driver mitigate some travel or traffic related problems presently affecting the vehicle. Some vehicles may also include telematics systems that can transmit some data to a data center.

### BRIEF DESCRIPTION OF THE DRAWINGS

Various examples will be described below with reference to the following figures.

FIG. 1 is a block diagram that includes an example traffic management system.

FIG. 2 is a block diagram of an example traffic management system that includes a non-transitory, machine-readable medium encoded with instructions to determine a flock traffic pattern.

FIG. 3 is a block diagram of an example traffic management system that includes a non-transitory, machine-readable medium encoded with instructions to provide a travel recommendation.

FIG. 4 is a block diagram of an example apparatus included in a connected vehicle.

FIG. 5 is a flowchart of an example method for determining a flock traffic pattern.

FIG. 6 is a flowchart of an example method for providing a travel recommendation.

FIG. 7 is a flowchart of an example method for receiving search data related to a search for a vehicle.

FIG. 8 is illustrates an example traffic management system.

### DETAILED DESCRIPTION

Traffic-related problems, such as travel delays, congestion, and accidents, as well as minor inconveniences, may be caused by continuously changing variables. For example, such variables may include weather, road debris, changing traffic patterns, distracted driving, facility closures, and other variables. Although some vehicles may be equipped with features, such as anti-lock brakes, traction control, electronic stability control, obstacle detection sensors, and the like, which may help a vehicle operator mitigate some travel or traffic related problems presently affecting the vehicle, it also may be useful for vehicle operators to be informed of or react to continuously changing variables and their impact on travel farther down the road, particularly changing variables that are out of sight of the vehicle operator. Unawareness of such changing variables may, in some cases, further exacerbate some traffic-related problems. For example, chain-reaction multi-vehicle accidents oftentimes may occur when vehicle operators do not have sufficient time to see an accident or poor road condition, comprehend the situation, and react. Some vehicles may include telematics systems that can transmit some data to a data center, but many legacy vehicles without such systems still remain in service. Accordingly, a traffic management system that can receive data from connected vehicles, determine the presence of non-connected or legacy vehicles, infer traffic patterns, and provide appropriate travel recommendations to the connected vehicles may be useful for improving road safety and convenience.

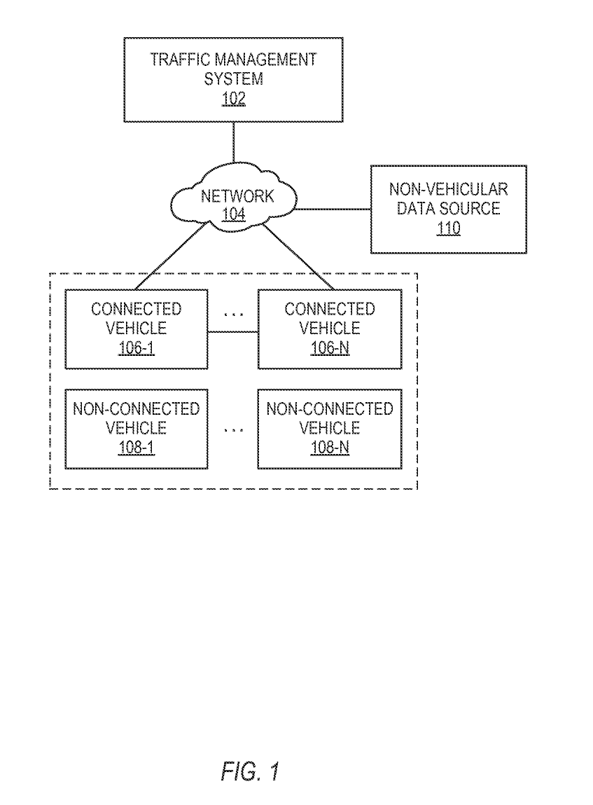

FIG. 1 is a block diagram illustrating a traffic management system 102 that may communicate with a network 104. For example, the traffic management system 102 may include any wired or wireless electronic communications technology (e.g., USB, FireWire, Ethernet, optical fiber, Wi-Fi, Bluetooth, cellular communications, satellite communications, short or long-range radios, near-field communications, and the like). Additionally, FIG. 1 illustrates a plurality of vehicles, including connected vehicles 106-1 through 106-N and non-connected vehicles 108-1 through 108-N. The connected vehicles 106-1 through 106-N may communicate (e.g., transmit and/or receive data) with the network 104 and thereby with the traffic management system 102, and additionally or alternatively, the connected vehicles 106-1 through 106-N may communicate with each other. For example, the connected vehicles 106-1 through 106-N may include wireless electronic communications technology (e.g., cellular communications, satellite communications, short or long-range radios, Wi-Fi, Bluetooth, near-field communications, and the like). In some implementations, the connected vehicles 106-1 through 106-N may communicate with the traffic management system 102 through an opt-in permission-based scheme. In further implementations, operators of the connected vehicles 106-1 through 106-N may interact with the traffic management system 102 (through, for example, a user interface of the connected vehicle or through a network-connected electronic device such as a smartphone or a computer) to select or restrict the types of data to transmit to and/or receive from the traffic management system 102 and to provide travel preferences to the traffic management system 102 such as a preferred traffic density, a preferred road type (e.g., highway, local road, toll-road), a preference for smooth-flowing traffic over stop-and-start traffic, vendor preferences (e.g., fuel stations, restaurants, etc.), and other preferences.

The plurality of vehicles illustrated in FIG. 1 may also include non-connected vehicles 108-1 through 108-N, which cannot communicate cannot or does not transmit and/or receive electronic data) with the network 104 or other vehicles for various reasons, such as having opted-out of interactions with the traffic management system 102, a lack of electronic communications technology, or incompatible, inoperative, or disabled electronic communications technology. In some implementations, the connected vehicles 106-1 through 106-N and the non-connected vehicles 108-1 through 108-N may be traveling on the same road, as represented by the dashed box in FIG. 1. In some implementations, a non-vehicular data source 110 may also be in communication with the network 104, and moreover, the traffic management system 102 may access data from the non-vehicular data source 110 (e.g., map data, weather data, news data, etc.).

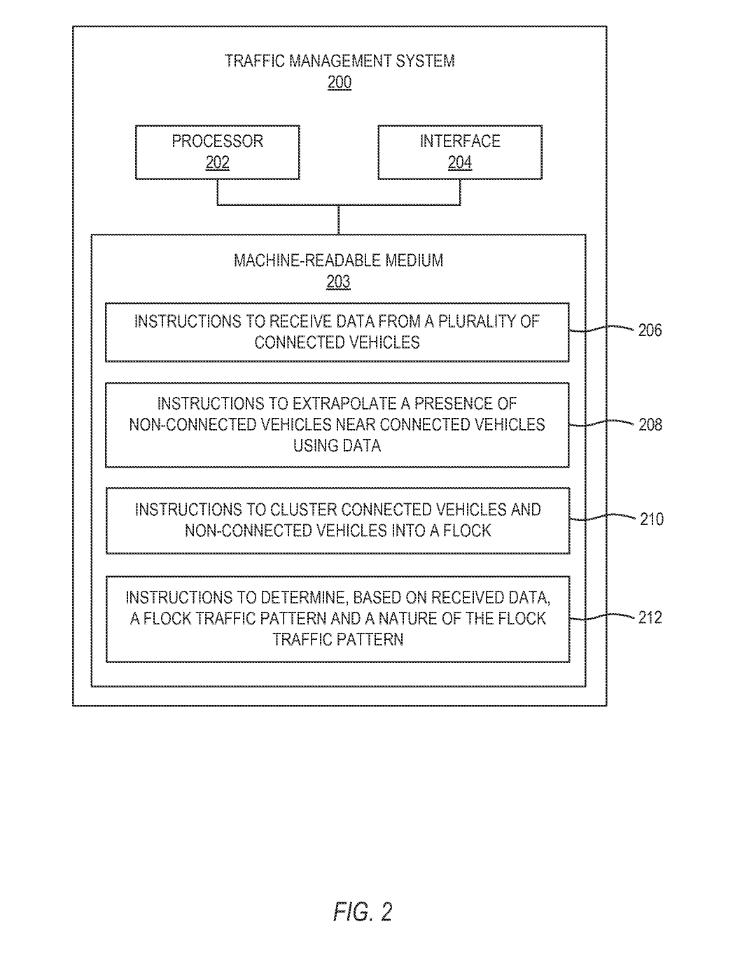

FIG. 2 is a block diagram illustrating a processor-based traffic management system 200 that includes a machine-readable medium encoded with example instructions to determine a flock traffic pattern according to an example implementation. In some implementations, the traffic management system 200 may serve as or form part of the traffic management system 102 of FIG. 1. In some example implementations, the traffic management system 200 may be or form part of a computing device, such as a server, a desktop computer, a desktop computer, a workstation, a laptop computer, or the like. In some implementations, the traffic management system 200 may be or form part of a cloud-based service. In some implementations, the traffic management system 200 is a processor-based system and may include at least one processor 202 coupled to a machine-readable medium 203. The processor 202 may include a single-core processor, a multi-core processor, an application-specific integrated circuit, a field programmable gate array, and/or other hardware device suitable for retrieval and/or execution of instructions from the machine-readable medium 203 (e.g., instructions 206, 208, 210, 212) to perform functions related to various examples. Additionally or alternatively, the processor 202 may include electronic circuitry for performing the functionality described herein, including, but not limited to, the functionality of instructions 206, 208, 210, and/or 212. With respect to the executable instructions represented as boxes in FIG. 2, it should be understood that part or all of the executable instructions and/or electronic circuits included within one box may, in alternate implementations, be included in a different box shown in the figures or in a different box not shown.

The machine-readable medium 203 may be any medium suitable for storing executable instructions, such as random access memory (RAM), electrically erasable programmable read-only memory (EEPROM), flash memory, hard disk drives, optical discs, and the like. In some example implementations, the machine-readable medium 203 may be a tangible, non-transitory medium, where the term “non-transitory” does not encompass transitory propagating signals. The machine-readable medium 203 may be disposed within system 200, as shown in FIG. 2, in which case the executable instructions may be deemed “installed” on the system 200. Alternatively, the machine-readable medium 203 may be a portable (e.g., external) storage medium, for example, that allows system 200 to remotely execute the instructions or download the instructions from the storage medium. In this case, the executable instructions may be part of an “installation package.” As described further herein below, the machine-readable medium 203 may be encoded with a set of executable instructions 206, 208, 210, 212.

In some implementations, the traffic management system 200 may include an interface 204, which may include any wired or wireless electronic communications technology (e.g., USB. FireWire, Ethernet, optical fiber, Wi-Fi, Bluetooth, cellular communications, satellite communications, short or long-range radios, near-field communications, and the like). The traffic management system 200 may communicate with a network by way of the interface 204.

Instructions 206, when executed by the processor 202, may receive data from a plurality of connected vehicles at the interface 204. For example, each connected vehicle may be equipped with a plurality of sensors and a wireless communication module. The plurality of sensors may provide or output data regarding the operation of the vehicle, and additionally or alternatively, the vehicle may further process or analyze sensor data (e.g., by way of an on-board processor, controller, analysis module, or the like) to provide additional data. The vehicle may use its wireless communication module to communicate with the traffic management system 200 directly or via the network, and more particularly, to transmit data (either direct from the sensors or after further processing) to the traffic management system 200. In some implementations, the traffic management system 200 may receive the data on a repeated, periodic, or occasional basis.

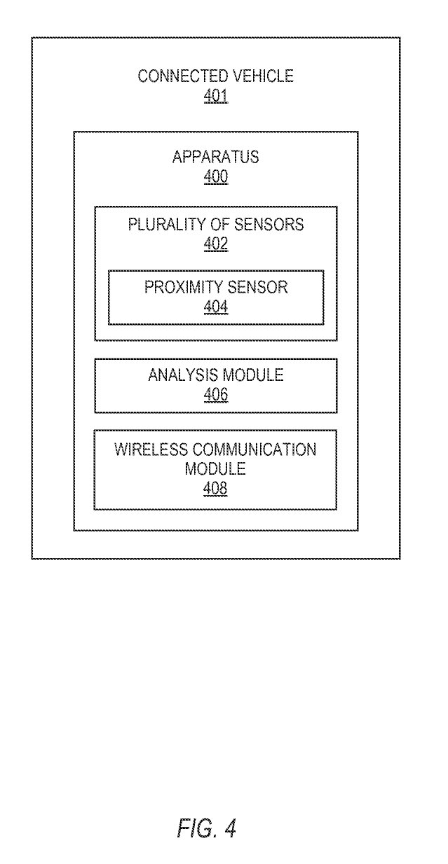

The data received by instructions 206 from a connected vehicle may be intrinsic or extrinsic to the vehicle. For example, the data may include a kinematic quantity of the vehicle (e.g., acceleration, velocity, roll, pitch, yaw, wheel speed, vibration frequency and amplitude, etc.). In some implementations, the data may include a vehicle specification, such as a type of the vehicle (e.g., including broad categorizations such as car, truck, bus, motorcycle, etc., and more particularly, a make and model of the vehicle), a mass of the vehicle (or a gross vehicle weight rating), a use of the vehicle (e.g., including categories such as passenger, commercial, civilian, government, military, emergency, non-emergency, or any permissible combination thereof), and the like. In some implementations, the data may relate to an operator input, such as throttle or accelerator position, brake pressure, steering angle, and the like. In some implementations, the data may include an indication that a vehicle safety feature is or has been activated (e.g., an anti-lock braking system, a traction control system, an electronic stability control, an emergency brake assist system, a lane departure warning system, an obstacle detection sensor system, an airbag inflation, etc.). In some implementations, the data may include a road condition (e.g., dry, wet, rain, snow, ice, mud, gravel, rock, sand, etc.). In some implementations, the data may include a weather condition (e.g., temperature, precipitation, etc.). In some implementations, the data may include GPS data. In some implementations, the data may include a camera image (or a stream of images) from a camera of the vehicle. In some implementations, the data may include a proximity measurement (e.g., from an ultrasonic sensor, a laser/infrared sensor, from the camera, etc.). In some implementations, the data may include travel convenience information, which may be provided, for example, by a user of the vehicle (e.g., a driver or a passenger) through a vehicle's user interface, which serves as a sensor in this case. For example, a user may provide travel convenience information based on recent travels related to fuel prices, whether facilities (e.g., fuel stations, restaurants, rest areas, etc.) are open or closed, and road and traffic conditions (e.g., potholes, construction, lane closures, road closures, bridge closures, etc.). The foregoing examples of data are not intended to be exhaustive but should be understood to illustrate that the traffic management system 200 is flexible and can accept a wide variety of data. The vehicle sensors and data will be described further herein below, with respect to FIG. 4.

In some implementations, the data received by instructions 206 may be stored in a database on a data storage (e.g., hard disk drive, solid state drive, tape library, optical storage media, volatile or non-volatile memory, or any other machine-readable medium suitable for storing data) of the traffic management system 200. The database may have class inheritance properties based on vehicle manufacturer platforms. As an illustration, the database may be structured as a hierarchical model, with classes such as, in descending order, vehicle type (e.g., classes of car, truck, motorcycle, etc., or classes based on number of wheels or axles), make, platform, model, and capabilities/features. Accordingly, by virtue of storing data in this manner, vehicle models and model variations may be managed efficiently. For example, a vehicle manufacturer may develop a platform with a multi-year lifetime, and may further develop different vehicle models and model trim levels based on that platform on an annual basis. In such a case, the platform may correspond to a superclass of the database and individual models based on the platform may correspond to subclasses of the database. As new capabilities or features are added to individual models, additional subclasses may be added to that model, the subclasses inheriting the characteristics of the superclass platform, which may provide for efficient data storage and access.

Instructions 208, when executed by the processor 202, may extrapolate a presence of non-connected vehicles near connected vehicles using the data (e.g., at least some of the data received by instructions 206). For example, in some cases, the traffic management system 200 may register or track connected vehicles and the locations thereof by virtue of data communications between the connected vehicles and the traffic management system 200, but the traffic management system 200 may not be able to register or track non-connected vehicles for lack of communications. Accordingly, it may be useful for the traffic management system 200 to gain awareness of non-connected vehicles by way of connected vehicles. In some implementations, instructions 208 may extrapolate the presence of non-connected vehicles around the connected vehicles using proximity measurement data or camera image data from the connected vehicles. More particularly, instructions 208 may analyze the data received by the instructions 206 to estimate or determine relative positions of vehicles (i.e., the positions of non-connected vehicles relative to connected vehicles, as well as non-connected vehicles to non-connected vehicles and connected vehicles to connected vehicles) in terms of, for example, distances between vehicles, azimuth angles between vehicles (e.g., a clock-based bearing), elevations between vehicles, velocity differences between vehicles, or other suitable measurements. In some implementations, instructions 208 may also incorporate other data, such as GPS data, from the connected vehicles to supplement or enrich the extrapolation.

Instructions 210, when executed by the processor 102, may cluster or group connected vehicles and non-connected vehicles into a flock. For example, a “flock” may refer to as a group of vehicles on a road, and more particularly, a group of vehicles within a certain proximity to one another. In some implementations, a flock of vehicles is defined by instructions 210 performing a cluster analysis based on the presence information and relative positions of connected vehicles and non-connected vehicles extrapolated by instructions 208 (and additionally or alternatively, data received at instructions 206, such as GPS data). For example, various cluster analysis techniques may be implemented, such as hierarchical clustering, centroid-based clustering, distribution-based clustering, density-based clustering, or other suitable cluster analysis techniques. As but an illustration, a collective of connected vehicles and/or non-connected vehicles traveling together closely and in the same general direction may be clustered as a flock, but by contrast, a small number of vehicles (e.g., two or three) traveling on the same road may be deemed insufficient to define a flock.

Instructions 212, when executed by the processor 102, may determine, based on received data (including any information derived from the data, such as the relative positions extrapolated by instructions 208), a traffic pattern of the flock clustered by instructions 210 and a nature of the flock traffic pattern. For example, the term “flock traffic pattern” may refer to the way a flock is organized. More particularly, instructions 212 may analyze the received data to describe a flock traffic pattern in terms of traffic properties such as, for example, traffic density (e.g., a number of flock vehicles per unit length or unit area), vehicle proximity (e.g., average and variance of distance between flock vehicles), speed/velocity and/or acceleration of the flock (e.g., average and variance, which may also indicate whether flock traffic exhibits stop-start patterns or is free flowing), flow of the flock (e.g., number of flock vehicles passing a reference point per unit of time), a shape of the flock, bottlenecks, and other suitable properties. To determine a flock traffic pattern, instructions 212 may analyze data on a per-vehicle basis or may analyze data on an aggregated basis for the entire flock. In some implementations, instructions 212 may fit the traffic properties into a chaos theory traffic model, a phase theory traffic model, or other suitable traffic models.

In some implementations, instructions 212 may also determine a nature (i.e., a source or cause) of a flock traffic pattern based on the received data. For example, instructions 212 may include an inference engine which utilizes logical rules and a knowledge base to infer the nature of a flock traffic pattern from the flock traffic pattern itself (e.g., the traffic properties described above) and/or data from the connected vehicles. Examples of natures of flock traffic patterns may include road conditions (e.g., ice, snow, rain, gravel, slippery, broken pavement, etc.) and accidents. As but one illustration, instructions 212 may determine that an icy road condition is the source or cause of a flock traffic pattern by virtue of the received data indicating activation of safety features of a majority of connected vehicles in a flock (e.g., on-demand all-wheel drive, electronic stability control, traction control, etc.), erratic vehicle proximities or densities, vehicle kinematics consistent with skid conditions (e.g., significant yaw), low temperature (e.g., from vehicle ambient temperature sensors), or any combination of the foregoing. As another illustration, instructions 212 may determine that broken pavement or potholes are the cause of a flock traffic pattern based on characteristic vibration kinematics and vehicle suspension telemetry data. As another illustration, instructions 212 may determine that an accident in the left lane is the source or cause of a present flock traffic pattern, based on the flock traffic pattern and the relative positions of connected and non-connected vehicles indicating that the flock is bottlenecking down to the right lane, the flock density increasing towards the bottleneck, the average flock speed decreasing towards the bottleneck, minimal or no kinematics consistent with skid conditions, minimal or no activation of vehicle safety features, or any combination of the foregoing. As but one illustration, instructions 212 may determine that the nature of the flock traffic pattern is only volume-based congestion (e.g., no accidents or adverse road conditions) by virtue of low flock speed and high flock density with minimal or no kinematics consistent with skid conditions and minimal or no vehicle safety feature activations in the flock. In the preceding illustrations, a higher number of factors being true may raise the likelihood or probability of a particular inference over a different possible inference.

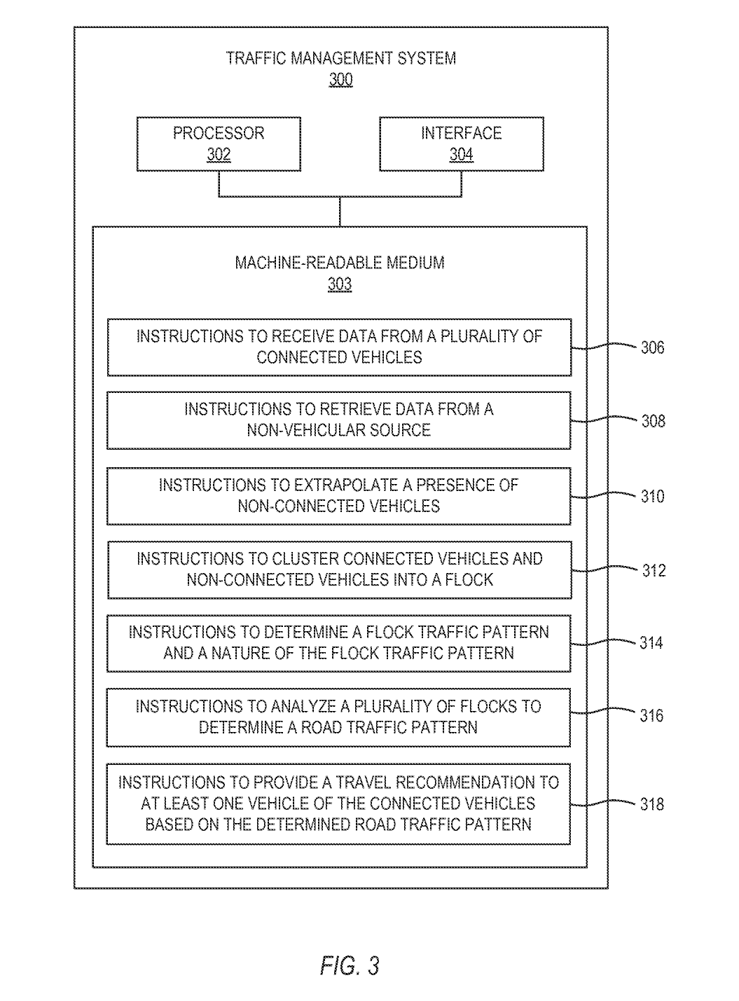

FIG. 3 is a block diagram illustrating a processor-based traffic management system 300 that includes a machine-readable medium encoded with example instructions to provide a travel recommendation according to an example implementation. In some implementations, the traffic management system 300 may serve as or form part of the traffic management system 102 of FIG. 1. The traffic management system 300 may include a processor 302 coupled to a machine-readable medium 303, and an interface 304. The processor 302, the machine-readable medium 303, and the interface 304 may be analogous in many respects to the processor 202, the machine-readable medium 203, and the interface 204 of FIG. 2. Additionally, as with the traffic management system 200, the traffic management system 300 may be or form part of a computing device, such as a server, a desktop computer, a desktop computer, a workstation, a laptop computer, or the like, and may be or form part of a cloud-based service. As described in more detail below, machine-readable medium 303 may be encoded with processor executable instructions, including, but not limited to, instructions 306, 308, 310, 312, 314, 316, 318.

Instructions 306 may be analogous in many respects to instructions 206 on machine-readable medium 203 described above. As with instructions 206, instructions 306 may, when executed by the processor 302, receive data from a plurality of connected vehicles at the interface 304. Instructions 308, when executed by the processor 302, may retrieve data from a non-vehicular source. For example, such data may relate to traffic and may include but are not limited to weather data, map data, traffic regulations (e.g., speed limits, passing zones, etc.), traffic camera feeds and data, historic traffic patterns, construction data, and/or news data. In some implementations, instructions 308 may access the data from public, private, government, or other data sources over a network via interface 303. In some implementations, instructions 308 may access the data from a data storage included in the traffic management system 300. Data received from non-vehicular sources by instructions 308 may be deemed static data and data received from connected vehicles by instructions 306 may be deemed dynamic data, by virtue of the vehicle data generally changing on a shorter time scale than the non-vehicular source data. As will be described further herein below, data from non-vehicular sources may be useful for at least some functions performed by the traffic management system 300, such as flock determination, traffic pattern analysis, and providing a travel recommendation.

Instructions 310 may be analogous in many respects to instructions 208, and when executed by the processor 302, instructions 310 may extrapolate a presence and relative position of non-connected vehicles near connecting vehicles based on the data received by instructions 306. Instructions 312 may be analogous in many respects to instructions 210 on machine-readable medium 203 described above. As with instructions 210, instructions 312 may, when executed by the processor 302, cluster or group connected vehicles and non-connected vehicles into a flock. In some implementations, instructions 312 may incorporate data from non-vehicular sources, such as maps, speed limits, historic traffic patterns, and the like, to inform or constrain the cluster analysis.

Instructions 314 may be analogous in many respects to instructions 212 on machine-readable medium 203 described above. As with instructions 212, instructions 314 may, when executed by the processor 302, determine a traffic pattern of the flock and a nature of the flock traffic pattern. To determine the flock traffic pattern and nature thereof, instructions 314 may analyze data received by instructions 306 in a manner similar to that described above with respect to instructions 212, and additionally or alternatively, may analyze data received by instructions 308 from non-vehicular sources. As one illustration, instructions 314 may detect a bottleneck flock traffic pattern based on relative vehicle positions, and by further analyzing non-vehicular source data such as construction reports, instructions 314 may accept or reject construction as a cause of the flock traffic pattern. Moreover, by rejecting construction as a cause of the flock traffic pattern, instructions 314 may increase the probability of other potential causes of the bottleneck flock traffic pattern, such as a traffic accident or road debris. As another illustration, in a case where data from connected vehicles imply reduced vehicle control (e.g., activation of vehicle safety features and/or kinematic data consistent with skids or traction loss), instructions 314 may analyze weather data from non-vehicular sources that indicate the occurrence of low temperatures or cold weather events to corroborate an inference of icy road conditions as the nature of the flock traffic pattern. On the other hand, in the same illustration, weather data that indicate high temperatures and clear weather conditions may lead to an inference of different road hazards (e.g., oil slick, road debris, etc.) as the nature of the flock traffic pattern.

Instructions 316, when executed by the processor 302, may analyze a plurality of flocks to determine a road traffic pattern, that is, a traffic pattern over a portion of road that includes a plurality of flocks. In some implementations, instructions 316 analyzes data provided from instructions 312 and 314 for multiple flocks. For example, instructions 312 may cluster connected and non-connected vehicles on the same or different road into a plurality of flocks, and instructions 314 may determine a flock traffic pattern and nature thereof for each flock of the plurality of flocks. Instructions 316 may compare the flock traffic patterns of nearby flocks of the plurality of flocks, such as, for example, consecutive flocks traveling in the same direction on the same road, to identify traffic patterns (and the natures thereof) along that road. Instructions 316 may further analyze road traffic patterns along different roads, such as the road traffic patterns of different routes to a destination. As an illustration, analysis of a plurality of flocks by instructions 316 may identify a traffic shockwave and related characteristics, such as a velocity of the traffic shockwave.

Instructions 318, when executed by the processor 302, may provide a travel recommendation to at least one vehicle of the connected vehicles via the interface 303. In some implementations, a travel recommendation may be provided to a particular connected vehicle based on or in response to the flock traffic pattern of the flock in which the particular connected vehicle is clustered. In some implementations, a travel recommendation may be provided to a particular connected vehicle based on or in response to road traffic patterns, and more particularly, road traffic patterns based on flocks traveling ahead of the particular connected vehicle. Examples of instructions 318 will now be discussed with reference to such particular connected vehicle.

For example, in response to detection of a skid condition or a poor road condition ahead of the particular connected vehicle, instructions 318 may transmit a recommendation to activate vehicle safety features (such as on-demand all-wheel drive), to reduce speed, to drive in a particular lane that is less affected by the condition, or other suitable action. In some implementations, the travel recommendation may also command or cause the connected vehicle to activate a particular feature, such as vehicle safety features, rather than merely providing a recommendation to do so. By virtue of providing the foregoing travel recommendation, the traffic management system 300 may improve road safety. To illustrate, as described above, chain-reaction multi-vehicle accidents oftentimes may occur when vehicle operators do not have sufficient time to see an accident or poor road condition, comprehend the situation, and react. However, in some instances, a chain-reaction may be broken and the severity of an accident may be reduced, owing to travel recommendations provided by a traffic management system as described herein.

As another example of providing a travel recommendation, in response to certain traffic patterns, instructions 318 may recommend to the particular connected vehicle an alternate route or routes to the vehicle's destination (e.g., a destination entered in the vehicle's GPS), the alternate route(s) meeting one or more of the vehicle operator's preferences, such as a preference for traffic density, a preference for free flowing traffic over stop-start traffic, a preference between travel time and travel distance, and the like. Such preferences may be provided by vehicle operators to the traffic management system 300 (and stored in a data storage thereof), in a manner similar to that described above with respect to traffic management system 102.

As another example, the travel recommendation may also be based on other data received from connected vehicles that may not necessarily relate to flock or road traffic patterns. For example, data received by the traffic management system 300 may relate to fuel prices or to facility closures, particularly as reported by flocks ahead of the particular connected vehicle. Instructions 318 may utilize such data to automatically advise the particular connected vehicle of fuel prices ahead (particularly if the vehicle is low on fuel) or of facility closures (such as the vehicle operator's preferred fuel station or restaurants), such that the vehicle operator may make informed driving decisions.

Although instructions 318 describe providing a travel recommendation to connected vehicles (via wireless electronic data communications over a network, for example), in some implementations, instructions 318 may additionally or alternatively provide travel recommendations in a different manner in order to reach non-connected vehicles. For example, instructions 318 may transmit a travel recommendation by way of a local-area low-power FM/AM radio broadcast or by way of a message displayed on electronic road signs.

FIG. 4 is a block diagram of an example apparatus 400 for a connected vehicle 401. For example, the connected vehicle 401 may be at least one of the connected vehicles 106-1 through 106-N or at least one of the connected vehicles described above with respect to FIGS. 2 and 3. The apparatus 400 may include a plurality of sensors 402, an analysis module 406, and a wireless communication module 408. A module, as referred to herein, can include a set of instructions encoded on a machine-readable and executable by a processor of the device. Additionally or alternatively, a module may include a hardware device comprising electronic circuitry for implementing functionality described herein. In some implementations, the wireless communication module 408 may include wireless electronic communications technology, such as cellular communications, satellite communications, short or long-range radios, Wi-Fi, Bluetooth, near-field communications, and the like.

In some implementations, the plurality of sensors 402 may provide data related to operation of the connected vehicle 401. For example, the plurality of sensors 402 may include at least one sensor or sensor-based system that monitors the operation of vehicle systems, such as an on-board diagnostics (OBD) unit, an engine control unit (ECU), a data acquisition system, or the like, and may be capable of reporting operator input (e.g., throttle or accelerator position, brake pressure, steering angle), engine parameters, and activation of vehicle safety features (e.g., an anti-lock braking system, a traction control system, an electronic stability control, an emergency brake assist system, a lane departure warning system, an obstacle detection sensor system, an airbag inflation, etc.), among other parameters. In some implementations, the plurality of sensors 402 may include at least one sensor for detecting kinematic quantities such as acceleration, velocity, roll, pitch, yaw, wheel speed, vibration frequency and amplitude, and the like. Other examples of sensors 402 include, for example, a camera (e.g., back-up camera, forward collision camera, side mirror camera, etc.), a proximity sensor 404 (e.g., an ultrasonic sensor, a laser/infrared sensor, or a camera-based proximity sensor), a GPS device, ambient temperature sensors, and precipitation sensors, among other sensors. In some implementations, the connected vehicle 401 may include a user interface by which a user (e.g., a driver or a passenger) may provide traffic or travel related information. In some implementations, the plurality of sensors 402 includes the proximity sensor 404 to sense other vehicles around the connected vehicle 401, the other vehicles including, for example, other connected vehicles as well as non-connected vehicles (that is, vehicles that do not have an apparatus 400 or more particularly, a wireless communication module 408). In some implementations, the sensors 402 (or another component of the apparatus 400, such as the analysis module 406 or a processor not shown) may further process or analyze the sensor data. For example, the sensors 402 may analyze wheel dynamics, suspension dynamics, kinematic quantities, safety feature data, and other data to determine a road surface or road condition, such as whether a road is dry, wet, icy, covered with gravel/dirt, etc.

The analysis module 406 may determine or extrapolate positions of the other vehicles (including non-connected vehicles) relative to the connected vehicle 401 based on data from the proximity sensor 404. In some implementations, the analysis module 406 may perform functions similar to instructions 208 or 310 described above. For example, as with instructions 208, the analysis module 406 may determine distances between the connected vehicle 401 and an adjacent vehicles and may determine an azimuth angle of adjacent vehicles relative to the connected vehicle 401.

In some implementations, the wireless communication module 408 may transmit information to a traffic management system (e.g., traffic management system 102, 200, or 300), the information including data provided by the plurality of sensors 402, as well as positions of other vehicles as extrapolated by the analysis module 406. The wireless communication module 408 may receive, from the traffic management system, a travel recommendation related to traffic conditions ahead of the connected vehicle 401 based on an analysis by the traffic management system of information from a plurality of connected vehicles (for example, as described above with respect to at least instructions 312, 314, 316, 318).

In addition to or as an alternative to communicating with the traffic management system, the wireless communication module 408 may also communicate with other connected vehicles. For example, in some cases, the wireless communication module 408 may not be able to communicate with the traffic management system (e.g., the traffic management system is unreachable or is offline) and may instead communicate with other connected vehicles. Depending in part on the type of wireless electronic communications technology employed in or available to the wireless communication module 408, the other connected vehicles with which the wireless communication module 408 communicates may be in close proximity or adjacent to the connected vehicle (e.g., using a short range wireless technology, such as Bluetooth), in the same flock as the connected vehicle 401 (e.g., using at least medium range wireless technology, such as Wi-Fi), or may be in a different flock than the connected vehicle 401 (e.g., using a long range wireless technology, such as cellular communications or satellite communications). In communicating with other connected vehicles, the wireless communication module 408 may, in some implementations, transmit information to other connected vehicles and also may receive information from other connected vehicles (e.g., information may include data provided by sensors such as sensors 402 and/or positions of other vehicles around the vehicle providing the information). The analysis module 406 may determine, based on at least the information received from other connected vehicles, a travel recommendation and a traffic pattern of a flock that includes the connected vehicle 401 (and in some implementations, the other connected vehicles). For example, the analysis module 406 may perform at least some of the functionality of instructions 312, 314, 316, 318 described above. In some implementations, the connected vehicle 401 via the wireless communication module 408 may transmit the traffic pattern determined by the analysis module 406 to a connected vehicle of another flock. Accordingly, instead of (or in addition to) relying on centralized traffic management at the traffic management system, connected vehicles may collaborate to perform peer-to-peer traffic management. For example, in some implementations, connected vehicles may employ swarm intelligence to support or improve flock and road traffic pattern analysis and provision of travel recommendations.

In another example implementations, a traffic management system may engage the apparatus 400 to assist in an emergency situation, particularly a situation where a law enforcement agency or another emergency service is searching for a particular vehicle (during e.g., an AMBER Alert, a Silver Alert, a stolen vehicle alert, a crime alert, or the like). In some implementations, the operator of the connected vehicle 401 may opt-in to assist in such an emergency situation. In participating in an emergency situation, the wireless communication module 408 may receive, from the traffic management system, a vehicle description related to an emergency situation. The vehicle description may include, for example, the make and model of the vehicle, a physical description of the vehicle, a license plate of the vehicle, or a vehicle identification number of the vehicle. The analysis module 406 monitors images from a camera (included among the plurality of sensors 402) on the connected vehicle 401 for a vehicle matching the vehicle description received from the traffic management system. If the vehicle being searched for is also a connected vehicle, the connected vehicle 401 may, in some implementations, communicate with the searched-for vehicle to match some of the vehicle description information (e.g., the vehicle identification number). If the analysis module 406 determines that a nearby vehicle matches the description, it may cause the wireless communication module 408 to contact the traffic management system with an image of the vehicle, a GPS location, and other relevant information.

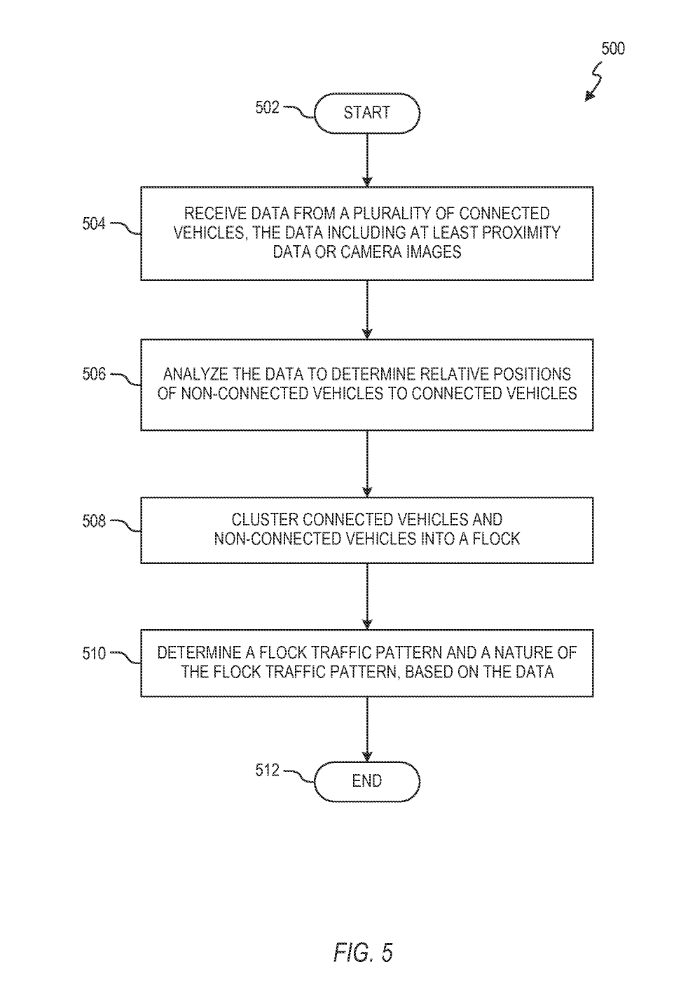

FIG. 5 is a flowchart of an example method 500 for determining a flock traffic pattern according to an implementation. Method 500 may be described below as being executed or performed by a traffic management system, such as the traffic management system 200 of FIG. 2. Various other suitable traffic management systems may be used as well, such as, for example, traffic management system 102 or 300. Method 500 may be implemented in the form of executable instructions stored on a machine-readable storage medium and executed by at least one processor of the traffic management system 200, and/or in the form of electronic circuitry. In some implementations of the present disclosure, one or more blocks of method 500 may be executed substantially concurrently or in a different order than shown in FIG. 5. In some implementations of the present disclosure, method 500 may include more or less blocks than are shown in FIG. 5. In some implementations, one or more of the blocks of method 500 may, at certain times, be ongoing and/or may repeat.

The method 500 may begin at block 502, and continue to block 504, where the traffic management system 200 may receive data from a plurality of connected vehicles. In some implementations, the data includes at least proximity data or camera images. In some implementations, the data includes or relates to a kinematic quantity, an operator input, an indication of vehicle safety feature activation, a weather condition, a travel convenience information, or GPS data. At block 506, the traffic management system 200 may analyze the data received at block 504 to extrapolate (or determine) relative positions of non-connected vehicles to connected vehicles. At block 508, the traffic management system 200 may cluster connected vehicles and non-connected vehicles into a flock. At block 510, the traffic management system 200 may determine a flock traffic pattern and a nature of the flock traffic pattern. For example, the traffic management system 200 may perform block 510 based on the data received at block 504. In some implementations, the flock traffic pattern may include a traffic density, a flock speed, a road condition, or other suitable traffic pattern property. At block 512, the method 500 may end.

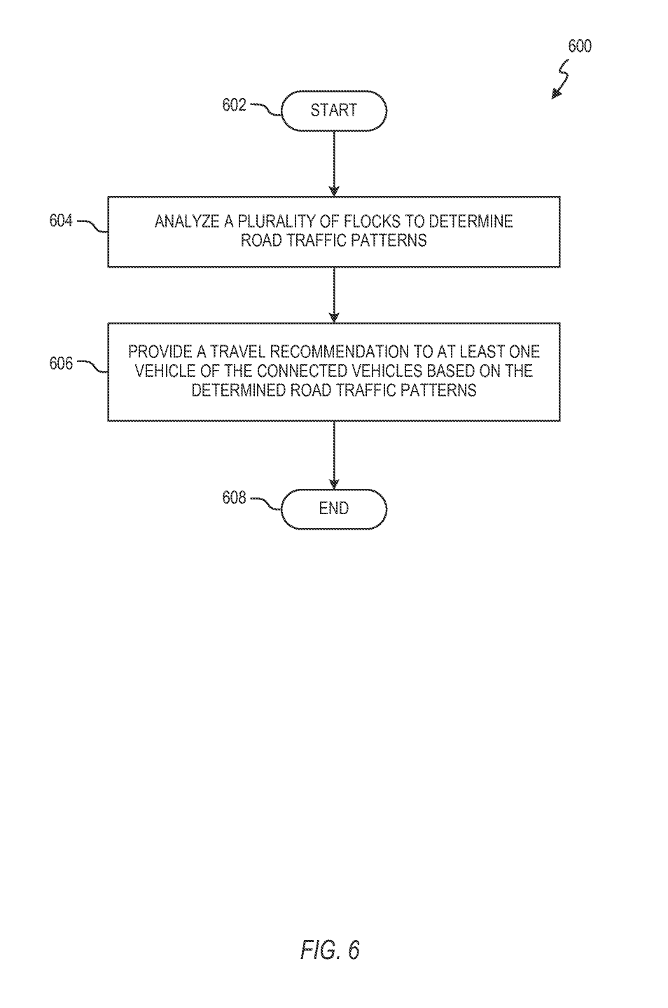

FIG. 6 is a flowchart of an example method 600 for providing a travel recommendation according to an implementation. Method 600 may be described below as being executed or performed by a traffic management system, such as the traffic management system 300 of FIG. 3. Various other suitable traffic management systems may be used as well, such as, for example, traffic management system 102 or 200. Method 600 may be implemented in the form of executable instructions stored on a machine-readable storage medium and executed by at least one processor of the traffic management system 300, and/or in the form of electronic circuitry. In some implementations of the present disclosure, one or more blocks of method 600 may be executed substantially concurrently or in a different order than shown in FIG. 6. In some implementations of the present disclosure, method 600 may include more or less blocks than are shown in FIG. 6. In some implementations, one or more of the blocks of method 600 may, at certain times, be ongoing and/or may repeat.

The method 600 may begin at block 602, and continue to block 604, where the traffic management system 300 may analyze a plurality of flocks to determine road traffic patterns. For example, in some implementations, block 602 may be performed after performing blocks 508, 510 of the method 500 on multiple flocks. At block 606, the traffic management system 300 may provide a travel recommendation to at least one vehicle of a plurality of connected vehicles. In some implementations, the travel recommendation may be based on the road traffic patterns determined at block 604. Additionally or alternatively, in some implementations, the travel recommendation may be based on a flock traffic pattern, such as a flock traffic pattern determined by performing block 510 of the method 500. At block 608, the method 600 may end.

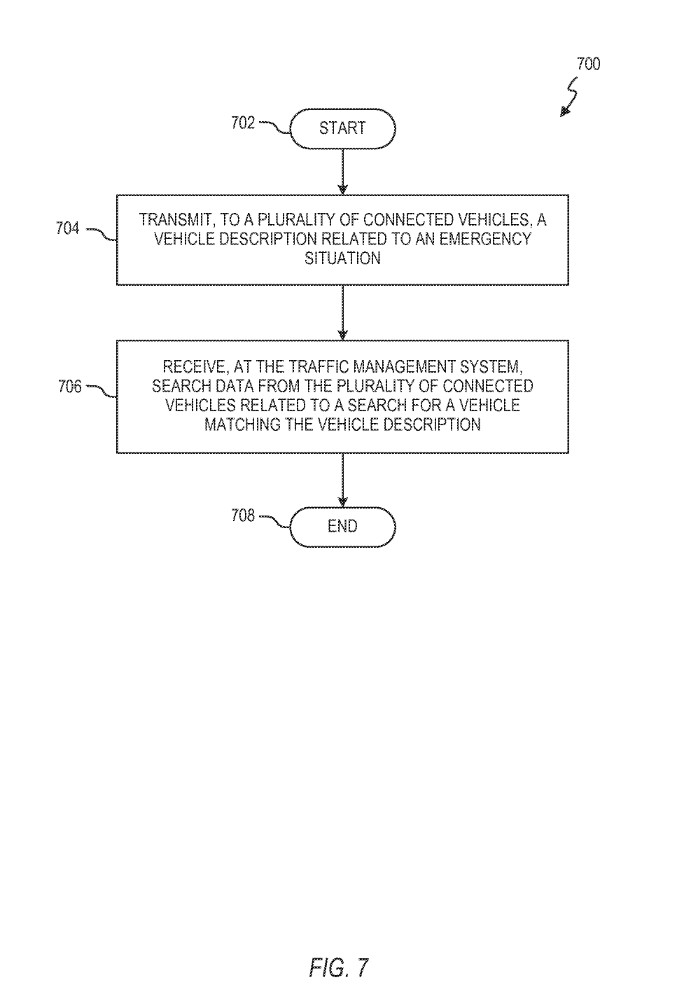

FIG. 7 is a flowchart of an example method 700 for receiving vehicle search data according to an implementation. Method 700 may be described below as being executed or performed by a traffic management system, such as the traffic management system 300 of FIG. 3. Various other suitable traffic management systems may be used as well, such as, for example, traffic management system 102 or 200. Method 700 may be implemented in the form of executable instructions stored on a machine-readable storage medium and executed by at least one processor of the traffic management system 700, and/or in the form of electronic circuitry. In some implementations of the present disclosure, one or more blocks of method 700 may be executed substantially concurrently or in a different order than shown in FIG. 7. In some implementations of the present disclosure, method 700 may include more or less blocks than are shown in FIG. 7. In some implementations, one or more of the blocks of method 700 may, at certain times, be ongoing and/or may repeat.

The method 700 may begin at block 702, and continue to block 704, where the traffic management system 300 may transmit, to a plurality of connected vehicles, a vehicle description related to an emergency situation. At block 706, the traffic management system 300 may receive search data from the plurality of connected vehicles related to a search for a vehicle matching the vehicle description. At block 708, the method 700 may end.

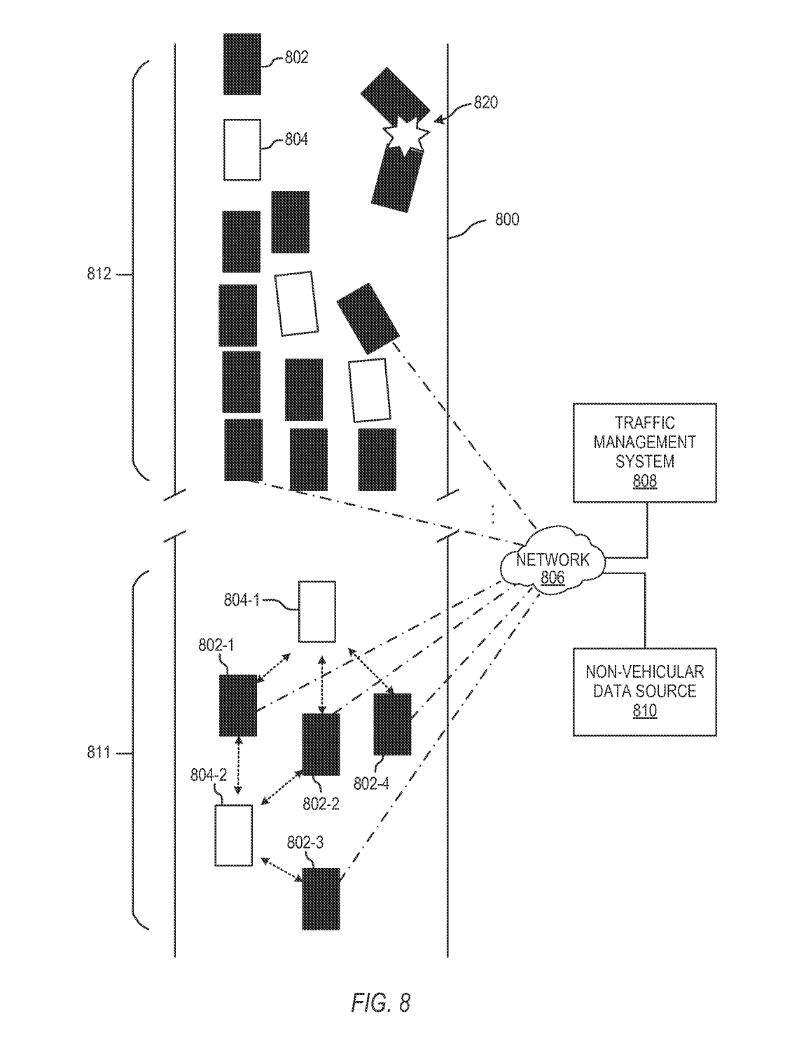

Some functionalities of the traffic management systems 200 and 300 will now be illustrated with reference to the non-limiting example of FIG. 8. FIG. 8 illustrates an example road 800 on which connected vehicles 802 (depicted as solid black rectangles in FIG. 8) and non-connected vehicles 804 (depicted as black-bordered white rectangles in FIG. 8) are driving. Each of the connected vehicles 802 may be connected (as represented by dot-dashed lines in FIG. 8, although some connections are omitted for clarity of illustration) to a network 806, and more particularly, may be connected on an opt-in basis. The connected vehicles 802 may be analogous to, for example, the connected vehicles 106-1 through 106-N, the connected vehicle 401, or the connected vehicles described above with respect to FIG. 2 or 3. The non-connected vehicles may be analogous to, for example, the non-connected vehicles 108-1 through 108-N or the non-connected vehicles described above with respect to FIG. 2 or 3. A traffic management system 808 and a non-vehicular data source 810 may also be communication with the network 806. The traffic management system 808 may be analogous to, for example, the traffic management system 102, 200, or 300 described above. The non-vehicular data source 810 may be analogous to, for example, the non-vehicular data source 110 or the non-vehicular data source described above with respect to FIG. 3.

The traffic management system 808 may receive sensor data provided by the connected vehicles 802 via network 806, for example, by executing instructions 206 described above. The data may include proximity data or camera images. As an illustration, data from a connected vehicle 802-1 may include proximity data (as depicted by dotted arrow lines in FIG. 8) that indicate the presence of non-connected vehicles 804-1 and 804-2. In some implementations, the data may also indicate a distance and/or an angle of the non-connected vehicles 804-1 and 804-2 relative to connected vehicle 802-1. Similarly, a connected vehicle 802-2 may provide data that indicate the presence of the non-connected vehicles 804-1 and 804-2, a connected vehicle 802-3 may provide data that indicate the presence of the non-connected vehicle 804-2, and a connected vehicle 802-4 may provide data that indicate the presence of the non-connected vehicle 804-1. In some implementations, the connected vehicles also provide proximity data regarding other connected vehicles, although this is not depicted on FIG. 8 for clarity of illustration. The traffic management system 808 may analyze or synthesize the data received from the connected vehicles (e.g., 802-1, 802-2, 802-3, 802-4), which may also include GPS data from those vehicles, to determine or extrapolate the relative positions of the non-connected (e.g., 804-1, 804-2) and connected vehicles (e.g., 802-1, 802-2, 802-3, 802-4), by executing instructions 208 for example. Based on the extrapolated relative positions, the traffic management system 808 may cluster the non-connected (e.g., 804-1, 804-2) and connected vehicles (e.g., 802-1, 802-2, 802-3) into a flock 811, by executing instructions 210 for example. Similarly, the traffic management system 808 may cluster particular non-connected and connected vehicles into a separate flock 812, which may be traveling ahead of the flock 811 on the road 800.

The traffic management system 808 may determine a flock traffic pattern and a nature of the flock traffic pattern, by executing instructions 212 for example. For example, analysis of the flock 811 may indicate a high average flock speed and low flock density, which may further indicate a normal traffic condition. On the other hand, analysis of the flock 812 may indicate a different flock traffic pattern owing to a recent accident 820 in the right lanes of the road 800. By analyzing the flock 812, the traffic management system 808 may determine that traffic and flock shape is constrained to a bottleneck in the left lane, the traffic density has increased, and the average flock speed has decreased. Based on the foregoing example characteristics of flock 812 the traffic management system 808 may determine that an obstruction, such as debris or an accident, exists in the right lanes of the road 800 at the location of the flock 812. Taking flocks 811 and 812 together, the traffic management system 808 may determine an overall road traffic pattern, including for example a distance of the flock 811 from the accident 820. Based on the road traffic pattern, the traffic management system 808 may provide a travel recommendation to the connected vehicles of the flock 811 to slow down and merge left or to take a detour (e.g., if such detour is available and if faster than a delay caused by the accident 820). By virtue of the traffic management system 808, travel for at least some vehicles traveling on the road 800 may be made safer, more efficient, and/or more convenient.

In view of the foregoing description, it can be appreciated that a broad pool of real-time data may be collected from traveling vehicles, insight into traffic patterns may be inferred from such data, and travel recommendations may be provided to vehicle operators in view of such insight. Moreover, travel recommendations provided according to the foregoing description may improve road safety, reduce traffic congestion, and increase driver convenience or comfort.

In the foregoing description, numerous details are set forth to provide an understanding of the subject matter disclosed herein. However, implementation may be practiced without some or all of these details. Other implementations may include modifications and variations from the details discussed above. It is intended that the following claims cover such modifications and variations.

We claim:

1. A non-transitory machine readable medium storing instructions executable by a processor of a traffic management system, the non-transitory machine readable medium comprising:
instructions to receive data from a plurality of connected vehicles at an interface of the traffic management system;
instructions to extrapolate a presence of non-connected vehicles near connected vehicles using the data;
instructions to cluster connected vehicles and non-connected vehicles into a flock; and
instructions to determine, based on received data, a flock traffic pattern and a nature of the flock traffic pattern.

2. The non-transitory machine readable medium of claim 1, wherein the data used to extrapolate the presence of non-connected vehicles includes a proximity measurement or a camera image.

3. The non-transitory machine readable medium of claim 1, wherein the data relates to a kinematic quantity, a vehicle specification, an operator input, an indication of vehicle safety feature activation, a road condition, a weather condition, a travel convenience information, GPS data, or a camera image.

4. The non-transitory machine readable medium of claim 1, wherein the flock traffic pattern includes a traffic density or a flock speed, and the nature of the flock traffic pattern includes a road condition or an accident.

5. The non-transitory machine readable medium of claim 1, further comprising:
instructions to analyze a plurality of flocks to determine a road traffic pattern; and
instructions to provide, via the interface, a travel recommendation to at least one vehicle of the connected vehicles based on the flock traffic pattern or the road traffic pattern.

6. The non-transitory machine readable medium of claim 1, wherein the data is stored in a database on a data storage of the traffic management system, the database having class inheritance properties based on vehicle manufacturer platforms.

7. The non-transitory machine readable medium of claim 6, further comprising instructions to retrieve data from a non-vehicular source that is used by the instructions to provide the travel recommendation or the instructions to determine the flock traffic pattern and the nature of the flock traffic pattern.

8. A method comprising:
receiving, at a traffic management system, data from a plurality of connected vehicles, the data including at least proximity data or camera images;
analyzing the data, by the traffic management system, to extrapolate relative positions of non-connected vehicles to connected vehicles;
clustering connected vehicles and non-connected vehicles into a flock; and
determining, by the traffic management system, a flock traffic pattern and a nature of the flock traffic pattern, based on the data.

9. The method of claim 8, further comprising:
analyzing, by the traffic management system, a plurality of flocks to determine road traffic patterns; and
providing, by the traffic management system, a travel recommendation to at least one vehicle of the connected vehicles based on the flock traffic pattern or the road traffic patterns.

10. The method of claim 8, wherein
the data relates to a kinematic quantity, an operator input, an indication of vehicle safety feature activation, a weather condition, a travel convenience information, or GPS data, and
the flock traffic pattern includes a traffic density, a flock speed, or a road condition.

11. The method of claim 8, further comprising:
transmitting, to the plurality of connected vehicles, a vehicle description related to an emergency situation; and
receiving, at the traffic management system, search data from the plurality of connected vehicles related to a search for a vehicle matching the vehicle description.

12. An apparatus for a connected vehicle, comprising:
a plurality of sensors that provide data related to operation of the connected vehicle, the plurality of sensors including a proximity sensor to sense other vehicles around the connected vehicle, the other vehicles including non-connected vehicles;
an analysis module to determine positions of the other vehicles relative to the connected vehicle based on data from the proximity sensor; and
a wireless communication module to:
transmit information to a traffic management system, the information including data from the plurality of sensors and the extrapolated positions, and
receive, from the traffic management system, a travel recommendation related to traffic conditions ahead of the connected vehicle based on an analysis by the traffic management system of information from a plurality of connected vehicles.

13. The apparatus of claim 12, wherein
the wireless communication module is to:
transmit information to other connected vehicles, and
receive information from other connected vehicles, and
the analysis module is to determine, based on at least the received information, a travel recommendation and a traffic pattern of a flock that includes the connected vehicle.

14. The apparatus of claim 12, wherein the wireless communication module is to transmit the determined traffic pattern to a connected vehicle of another flock.

15. The apparatus of claim 12, wherein
the plurality of sensors includes a camera,
the wireless communication module is to receive, from the traffic management system, a vehicle description related to an emergency situation, and
the analysis module monitors images from the camera for a vehicle matching the vehicle description.
